(19) United States
(12) Patent Application Publication
(10) Pub. No.: US 2026/0292221 A1
(43) Pub. Date: Sep. 24, 2026

(54) SYSTEMS AND METHODS FOR MULTI-LAYERED VIDEO ENCODING

(71) Applicant: Tyco Fire & Security GmbH, Neuhausen am Rheinfall (CH)

(72) Inventors: Paul FEE, Belfast (GB); John MCCAMBRIDGE, Bangor (GB); Terence NEILL, Lisburn (GB); William WRIGHT, Neuhausen am Rheinfall (CH)

(21) Appl. No.: 19/568,424

(22) Filed: Mar. 16, 2026

Related U.S. Application Data
(60) Provisional application No. 63/774,603, filed on Mar. 19, 2025.

(51) Int. Cl. H04N 19/30; H04N 19/119; H04N 19/172; H04N 21/234; H04N 21/2347

(52) U.S. Cl. CPC H04N 19/30; H04N 19/119; H04N 19/172; H04N 21/23418; H04N 21/2347

(57) ABSTRACT

Example implementations include a method, apparatus and computer-readable medium of video encoding, including identifying sections of frames of a video, wherein at least one of the sections is identified as including a region of interest. The implementations further include partitioning each of the sections of the frames into video segments. Additionally, the implementations further include encoding each of the separate video segments separately with a respective video property to define a separately encoded video segment, wherein the first separately encoded video segment includes the at least one of the sections including the region of interest. Additionally, the implementations further include assembling each of the separately encoded video segments as a respective track layer in a multi-track video format.

### CROSS REFERENCE TO RELATED APPLICATION

This application claims the benefit of U.S. Provisional Application Ser. No. 63/774,603, entitled “SYSTEMS AND METHODS FOR MULTI-LAYERED VIDEO ENCODING” and filed on Mar. 19, 2025, the disclosure of which is incorporated by reference herein in its entirety.

### TECHNICAL FIELD

Aspects of the present disclosure relate generally to video encoding systems, and more particularly, to a video encoding method for encoding separate portions of a video with a respective video property.

### BACKGROUND

When encoding videos, different parts of a scene may deserve a different video property such as a higher frame rate or resolution. For example, in a casino, the area surrounding a gaming table may require a higher frame rate to capture detailed activity such as the player's faces, their hands, the table, or the like, while other areas such as a casino background or the dealer's face are less critical and can be streamed or recorded at a lower frame rate. One approach may involve using multiple video cameras to record different segments of a scene such that each video camera has their own separate video streams with their own respective video properties. However, this approach may have drawbacks, as deploying multiple cameras to capture the same scene at varying resolutions or frame rates increases equipment costs. Additionally, each camera produces a separate video stream, leading to redundant data storage and transmission. Moreover, coordinating multiple cameras for the same scene introduces synchronization challenges and demands greater processing power.

The problem addressed in the present disclosure concerns the inefficiencies of traditional video encoding systems, particularly in scenarios where different areas of a scene require varying levels of detail and/or frame rates. Conventional video encoding systems and methods are unable to resolve these issues. Accordingly, there exists a need for improvements in such systems.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of video encoding, comprising identifying a plurality of sections of a plurality of frames of a video, wherein at least one of the plurality of sections is identified as including a region of interest. The method further includes partitioning each of the plurality of sections of the plurality of frames into a plurality of separate video segments. Additionally, the method further includes encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest. Additionally, the method further includes assembling each of the plurality of separately encoded video segments as a respective track layer in a multi-track video format of the video for transmission or storage.

Another example aspect includes an apparatus for video encoding, comprising one or more memories and one or more processors coupled with one or more memories and configured to perform, individually or in any combination, the following actions. The one or more processors are configured to identify a plurality of sections of a plurality of frames of a video, wherein at least one of the plurality of sections is identified as including a region of interest. The one or more processors are further configured to partition each of the plurality of sections of the plurality of frames into a plurality of separate video segments. Additionally, the one or more processors are further configured to encode each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest. Additionally, the one or more processors are further configured to assemble each of the plurality of separately encoded video segments as a respective track layer in a multi-track video format of the video for transmission or storage.

Another example aspect includes an apparatus for video encoding, comprising means for identifying a plurality of sections of a plurality of frames of a video, wherein at least one of the plurality of sections is identified as including a region of interest. The apparatus further includes means for partitioning each of the plurality of sections of the plurality of frames into a plurality of separate video segments. Additionally, the apparatus further includes means for encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest. Additionally, the apparatus further includes means for assembling each of the plurality of separately encoded video segments as a respective track layer in a multi-track video format of the video for transmission or storage.

Another example aspect includes a computer-readable medium having instructions stored thereon for video encoding, wherein the instructions are executable by one or more processors, individually or in any combination, to identify a plurality of sections of a plurality of frames of a video, wherein at least one of the plurality of sections is identified as including a region of interest. The instructions are further executable to partition each of the plurality of sections of the plurality of frames into a plurality of separate video segments. Additionally, the instructions are further executable to encode each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest. Additionally, the instructions are further executable to assemble each of the plurality of separately encoded video segments as a respective track layer in a multi-track video format of the video for transmission or storage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 depicts a system diagram of a multi-region layered video encoding system, in accordance with example aspects of the present disclosure.

FIG. 2 is a block diagram of a process to select different regions of a video and encode segments of a video separately, in accordance with example aspects of the present disclosure.

FIG. 3 is a block diagram of an example of a computer device having components configured to perform a method of video encoding, in accordance with example aspects of the present disclosure.

FIG. 4 is a flowchart of an example of a method of video encoding, in accordance with example aspects of the present disclosure.

FIG. 5 is a flowchart of additional aspects of the method of FIG. 4, in accordance with example aspects of the present disclosure.

FIG. 6 is a flowchart of additional aspects of the method of FIG. 4, in accordance with example aspects of the present disclosure.

FIG. 7 is a flowchart of additional aspects of the method of FIG. 4, in accordance with example aspects of the present disclosure.

FIG. 8 is a flowchart of additional aspects of the method of FIG. 4, in accordance with example aspects of the present disclosure.

FIG. 9 is a flowchart of additional aspects of the method of FIG. 4, in accordance with example aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

When encoding video, different areas within a scene may exhibit varying levels of importance and require distinct encoding strategies. For instance, in a casino setting, the region surrounding a gaming table may warrant a higher frame rate to capture intricate details of player interactions, while other areas may not require the same level of precision (e.g., areas between gaming tables). As another example, in a bank surveillance setting, the region surrounding an automated teller machine (ATM) may also warrant a higher frame rate to capture intricate details of a person using the ATM, while a background may not require the same level of detail. Advances in artificial intelligence (AI) allow for the dynamic detection of objects or regions of interest, ensuring that critical elements are recorded in high resolution and at an optimal frame rate. Meanwhile, less significant portions of the scene can be encoded with lower detail, optimizing both storage and transmission efficiency.

One approach may involve using multiple cameras to capture the same area (or different areas) of a scene with individually optimized video properties. However, this approach may introduce several challenges. The increased hardware requirements and setup complexity demand precise calibration and positioning to ensure seamless coverage. Synchronization issues may arise due to variations in frame rate, exposure, or color calibration, leading to inconsistencies when stitching or analyzing footage. Additionally, deploying multiple cameras increases costs related to equipment, maintenance, and infrastructure for data transmission and storage. While each camera may optimize its encoding settings, managing multiple video streams still requires significant bandwidth and processing power, potentially causing latency, and complicating real-time applications such as surveillance or live broadcasting. Differences in encoding parameters across cameras can also disrupt scene continuity, making transitions between views appear unnatural or inconsistent. Furthermore, post-processing and analysis become more complex, requiring additional computational resources to align perspectives, correct inconsistencies, and ensure smooth integration. Improper camera placement may create gaps in coverage or redundant data, leading to inefficiencies in both recording and analysis.

The problem addressed in this present disclosure concerns the inefficiencies of traditional video encoding systems, particularly in scenarios where different areas of a scene require varying levels of detail and frame rates. The present disclosure introduces a multi-region layered video encoding approach that identifies specific sections of video frames as a region of interest and encodes them separately with their own optimal resolution and frame rates. The identified sections are then divided into distinct video segments, each encoded independently with different video parameters. The encoded segments are then assembled as layers within a multi-track video format, where each layer retains its own video properties, such as codec, resolution, or frame rate. In this way, allocation of resources to video encoding may be more precise.

The technical advantages of the present disclosure include improved resource allocation, minimized unnecessary data usage, and the ability to grant selective access to high-quality layers through encryption. In addition, the approach described in the present disclosure offers an efficient and adaptable solution for video surveillance and other applications. Notably, the present disclosure enables more precise allocation of video encoding resources, ensuring optimal performance where needed.

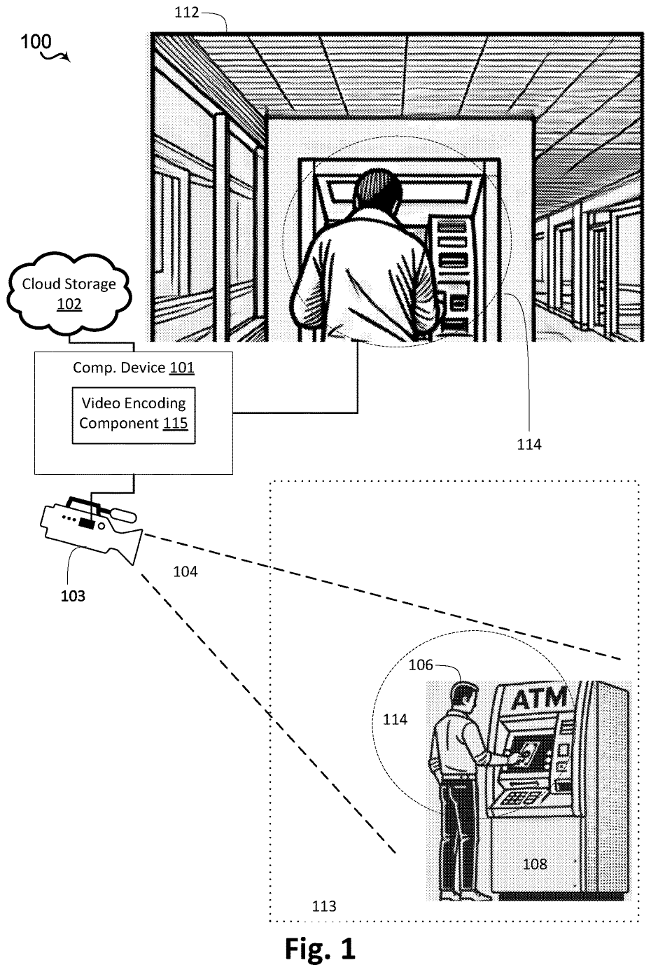

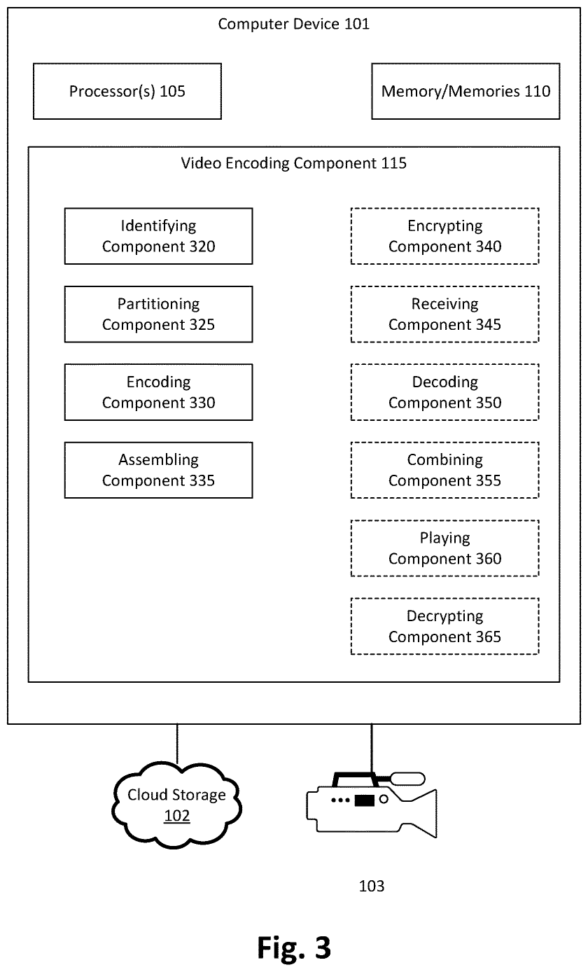

FIG. 1 depicts a system diagram of a multi-region layered video encoding system, in accordance with example aspects of the present disclosure. The multi-region layered video encoding system 100 is a system for identifying regions of interest in a video frame 112, splitting the video frame 112 (or image) into video segments, encoding the video segments separately and assembling the encoded video segments into a multi-track video format by a video encoding component 115 (described in FIG. 3).

As shown in FIG. 1, a computer device 101 may be configured to capture, by a camera 103 coupled with the computer device 101, a scene 113 of a bank with an ATM 108. Specifically, the computer device 101 is coupled with a camera 103 (or image sensor) positioned such that the field of view 104 of the camera 103 is ideally optimized to capture the scene 113 and focus on the ATM 108 in the video frame 112. The primary focus 114 of the scene 113 is the area where a person 106 actively interacts with the ATM 108. This ensures that the camera 103 is capturing clear visibility of the actions of the person 106, including inserting a card, entering a PIN, selecting transaction options, and/or retrieving cash or receipts. This targeted framing allows for enhanced monitoring, analysis, or security applications while minimizing the inclusion of extraneous background elements that are not relevant to the primary objective of capturing ATM interactions.

In some aspects, the computer device 101 may be connected to a cloud storage 102 that can efficiently store video footage from the camera 103 by transmitting recorded data to remote servers (not pictured) for secure and scalable storage or further downstream processing. When the camera 103 coupled with the computer device 101 captures video, the computer device 101 can process and encode the video frames of the video locally before uploading it to the cloud storage 102 in near real-time or at scheduled intervals, depending on network conditions and storage preferences. In some aspects, the encoding may be performed further in the downstream process either on another device locally or after being uploaded to the cloud storage 102.

Cloud storage 102 enables automatic backups, ensuring that video data is protected from local hardware failures, theft, or tampering. Additionally, cloud-based storage allows for remote access, enabling users to retrieve, review, and manage footage from any device with internet connectivity. Advanced cloud integration can also support AI-driven features such as object detection, facial recognition, and event-based recording, optimizing storage by prioritizing critical footage while reducing unnecessary data uploads. Security measures, including encryption and access controls, help safeguard the video data or video footage against unauthorized access.

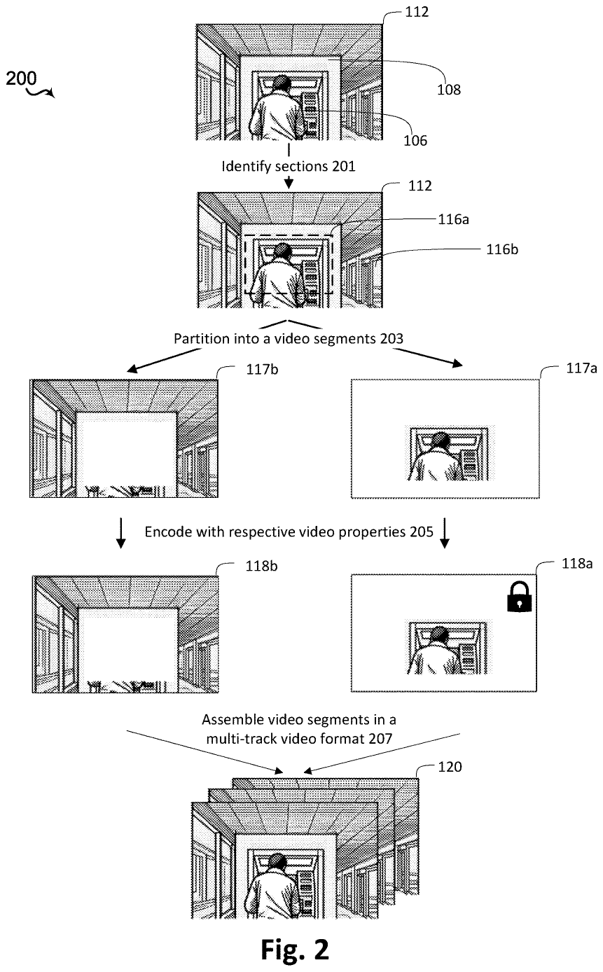

FIG. 2 depicts a block diagram of a process for identifying different regions of a video, encoding segments of a video separately, and then assembling video segments into a multi-track video format, in accordance with exemplary aspects of the present disclosure. As a non-limiting example and for the sake of brevity, FIG. 2 shows a process 200 for processing a video frame 112 in accordance with the present disclosure. Those of ordinary skill in the art will appreciate from the present disclosure that the identification, encoding, and assembly process is heavily simplified. One skilled in the art will appreciate that the machine learning model (ML model) utilized may have significantly large datasets with highly specific details due to the complexity and scale of modern software systems. Human cognition is limited in its ability to manually track and analyze these dependencies with the precision and efficiency required for accurate predictions. Furthermore, software code often includes dynamic execution behaviors, runtime optimizations, and external application programming interface (API) interactions that cannot be fully anticipated without automated analysis. ML models excel in recognizing patterns, processing large datasets, and making data-driven predictions, enabling them to analyze video frames efficiently and generate reliable computational models in a way that manual methods simply cannot achieve within a reasonable timeframe.

In some implementations, the process 200 illustrates the multi-region layered video encoding system 100 or a component thereof (e.g., the video encoding component 115 shown in FIG. 3) encoding a plurality of separate video segments with respective video properties (e.g., codec, resolution, framerate, bit rate, color depth, or the like) from the video frame 112. Here, the video frame 112 is unlabeled and unpartitioned and contains at least two unknown objects (e.g., a first unknown object that corresponds to an ATM 108 and a second unknown object that corresponds to a person 106).

In some implementations, the process 200 proceeds to identify 201 regions of interest. As shown here, the identifying component 320 from the video encoding component 115 identifies a first region of interest 116a including a person 106 actively interacting with the ATM 108 and a second region of interest 116b including a background. In some aspects, a user can predefine fixed coordinates of the video frame as a region of interest. For example, if the camera's 103 position is known and an object of interest (e.g., ATM 108) has a fixed location and will not move, the user can set these coordinates accordingly.

In some aspects, a trained ML model may be utilized to recognize one or more of an area of interest (e.g., the region surrounding the ATM 108) or an object of interest (e.g., person 106). This approach enhances accuracy by reducing reliance on predefined coordinates, enables adaptive detection in dynamic environments, and improves security by automatically recognizing relevant regions and objects in real time. For example, when a user sets fixed ROI coordinates, the system treats them as the initial mask, while a trained ML model concurrently recognizes areas/objects of interest. As another example, when the ML-updated mask differs, the system can prompt the user to adopt the updated regions for downstream processing. Once confirmed, the pipeline partitions the frame into segments and encodes them with distinct properties, assembling them as track layers such that updates are applied to the ROI efficiently without re-encoding the entire frame. The ML can also recommend trimming low-importance subregions (e.g., lower legs) and estimate savings by shifting pixels from a high-quality ROI track to a lower-quality base track, quantifying expected bytes per frame and extrapolating per hour/day

In some aspects, the process 200 may include examining a plurality of frames to identify an unchanged area (e.g., such as a background or the ATM 108) as a region of interest. This approach helps improve efficiency by reducing computational load, enhancing detection accuracy by filtering out irrelevant changes, and enabling more reliable tracking of dynamic objects (e.g., person 106) within the scene.

In some implementations, the process 200 proceeds to partition 203 each of the identified plurality of sections (e.g., first region of interest 116a and second region of interest 116b) into a first video segment 117a and a second video segment 117b. Dividing the video into segments allows each segment to have distinct properties, such as codec, resolution, frame rate, bit rate, or color depth. This approach optimizes resource allocation by prioritizing higher-quality settings for the most valuable parts of the scene such as the primary focus 114 of capturing the person 106 interacting with the ATM 108.

In some implementations, the process 200 proceeds to encode 205 each separate video segment (e.g., first video segment 117a and second video segment 117b) with a respective video property to define an encoded first video segment 118a and an encoded second video segment 118b. As an example, the encoded first video segment 118a (e.g., ROI) may be encoded with a higher resolution and higher frame rate than the encoded second video segment 118b (e.g., background/base), since the encoded first video segment 118a contains the more “interesting” region of interest such that more resources should be devoted to the first region of interest 116a. In some aspects, the process 200 may also include encrypting the first video segment 118a since the first region of interest 116a may contain sensitive information such as a user's pin number, a user's face, transactions with the ATM 108, etc. The region of interest may be designed either by a user or by ML designation.

In some implementations, the process 200 then proceeds to assemble 207 the first video segment 118a and the second video segment 118b into a multi-track video format 120 for downstream transmission or storage. This step is crucial for effectively combining separate encoded video segments 118a, 118b back into a unified format that can be easily managed, transmitted, or stored. The multi-track video format 120 allows for efficient synchronization and handling of different video layers or streams, enabling better control over content during downstream transmission (such as streaming) or storage. This approach ensures that video segments can be processed independently while still providing a seamless viewing experience for the end user. In some implementations, this yields a composite presentation in which regions of interest are carried on a higher-resolution and/or higher-frame-rate track, while background regions are carried on a lower-resolution and/or lower-frame-rate track. By allocating higher quality only to the most relevant portions of the scene, the system reduces bandwidth and storage without sacrificing fidelity where it matters most and preserves frame-accurate synchronization across tracks for seamless playback. This multi-track arrangement further enables selective access controls and targeted re-encoding of only the affected track if regions of interest change, improving security and operational efficiency.

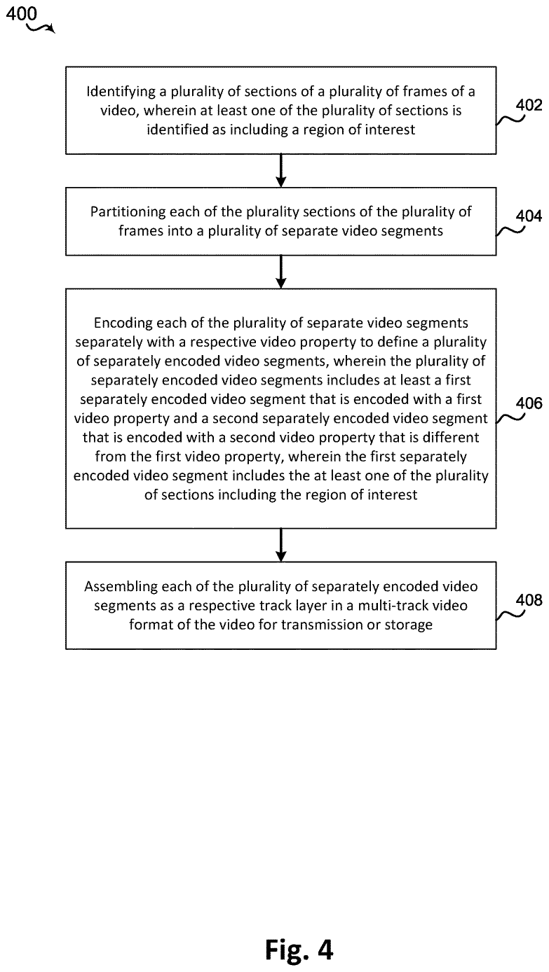

Referring to FIG. 3 and FIG. 4, in operation, computer device 101 may perform a method 400 of video encoding, such as via execution of video encoding component 115 by one or more processors 105 configured, individually or in any combination, to execute instructions to perform the following actions, and/or configured to communicate with one or more memories 110 to obtain the instructions to perform the actions.

At block 402, the method 400 includes identifying a plurality of sections of a plurality of frames of a video, wherein at least one of the plurality of sections is identified as including a region of interest. For example, in an aspect, computer device 101, one or more processors 105, one or more memories 110, video encoding component 115, and/or identifying component 320 may be configured to or may comprise means for identifying a plurality of sections of a plurality of frames of a video, wherein at least one of the plurality of sections is identified as including a region of interest.

For example, the identifying block at 402 may include capturing any environment or scene by a camera 103 (as shown in FIG. 1). For example, the environment may be outside of a bank. The environment or scene may contain fixed objects (e.g., ATM) and/or dynamic objects (e.g., people walking by or cars driving by). The process of identifying sections of a video frame based on an identification of at least one region of interest involves several steps. In some aspects, video frames may be segmented into multiple sections using grid-based division, edge detection, or super pixel clustering. In some aspects, the sections of the video frames may be analyzed for relevant features such as motion changes and/or object presence using deep machine learning models such as You Only Look Once (YOLO) or Faster Region-based Convolutional Neural Network (R-CNN).

Regions of interest may then be identified by detecting changes across video frames, recognizing predefined objects, or generating saliency maps to highlight important areas. In some aspects, to refine accuracy, temporal consistency is maintained using Kalman filters, Mean-Shift tracking, or deep-learning-based object tracking. The output then includes identified region of interest sections (e.g., first region of interest 116a and second region of interest 116b from FIG. 2), which may be annotated frames with bounding boxes or segmentation masks, and, in some cases, refined region of interest data for downstream tasks such as adaptive compression, event detection, or content-aware encoding. In this way, processing efficiency may be improved by focusing computational resources on meaningful areas and object recognition may be enhanced by filtering out irrelevant background data.

At block 404, the method 400 includes partitioning each of the plurality of sections of the plurality of frames into a plurality of separate video segments. For example, in an aspect, computer device 101, one or more processors 105, one or more memories 110, video encoding component 115, and/or partitioning component 325 may be configured to or may comprise means for partitioning each of the plurality of sections of the plurality of frames into a plurality of separate video segments.

For example, the partitioning at block 404 may include dividing a video into smaller, independently processed video segments based on the identified regions of interest or predefined criteria such as particular fixed coordinates. Each identified section containing a region of interest is isolated and assigned to a separate video segment, where different encoding parameters (e.g., resolution, frame rate, bit rate, or compression) may be applied based on content importance. Algorithms such as scene change detection, optical flow analysis, and background subtraction help determine segment boundaries by detecting transitions or stable regions. The output consists of multiple video segments, which can be stored, transmitted, or processed independently. This approach enhances video compression efficiency by allowing separate allocation of resources to different video segments.

At block 406, the method 400 includes encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest. For example, in an aspect, computer device 101, one or more processors 105, one or more memories 110, video encoding component 115, and/or encoding component 330 may be configured to or may comprise means for encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest.

For example, the encoding at block 406 may include encoding each video segment separately with distinct video properties by assigning different encoding parameters to individual video segments based on their content and importance. Each segment may be encoded independently with higher quality settings applied to video segments containing important content (e.g., faces, etc.) and lower-quality settings for less significant areas (e.g., static backgrounds). The output consists of multiple encoded video segments with different video properties.

At block 408, the method 400 includes assembling each of the plurality of separately encoded video segments as a respective track layer in a multi-track video format of the video for transmission or storage. For example, in an aspect, computer device 101, one or more processors 105, one or more memories 110, video encoding component 115, and/or assembling component 335 may be configured to or may comprise means for assembling each of the plurality of separately encoded video segments as a respective track layer in a multi-track video format of the video for transmission or storage.

For example, the assembling at block 408 may include combining different multiple encoded segments (e.g., each with distinct video properties) into separate track layers within a unified video file for efficient transmission or storage. The video segments are merged into a multi-track format using container formats such as Matroska, MKV, or streaming formats such as MPEG-DASH, ensuring seamless playback and synchronization. In some aspects, algorithms like multiplexing and metadata tagging help align segments and maintain playback consistency across different tracks. The output is a structured video file that allows a selection of video tracks/layers based on network conditions, user preference/permissions, or device capabilities. This approach improves storage efficiency by enhancing video quality in critical areas while reducing bandwidth for less important content.

In an alternative or additional aspect, the respective video property comprises at least one of a codec, a resolution, a framerate, a bit rate, a color depth, or an encoding profile. As an example, the video properties may include at least one of the codec, which specifies the compression algorithm (e.g., H.264, H.265, AV1) to balance quality and storage efficiency; resolution, which sets the spatial dimensions of the video (e.g., 1080p, 4K) to match display or bandwidth constraints; and frame rate, which controls the number of frames per second (e.g., 30 fps, 60 fps) for smooth motion rendering. Additionally, the bit rate determines data allocation per second to optimize quality versus file size, while color depth (e.g., 8-bit, 10-bit, HDR) enhances color accuracy and range.

In an alternative or additional aspect, the first video property comprises at least one of a first resolution or a first framerate and the second video property comprises at least one of a second resolution or a second framerate, wherein the first resolution is greater than the second resolution, and wherein the first framerate is greater than the second framerate. In this aspect, a base section of the plurality of sections of the plurality of frames of the video corresponds to a base layer of the video that includes an entirety of each of the plurality of frames, wherein the second separately encoded video segment corresponds to the base section of the plurality of sections.

This distinction allows for efficient encoding where more critical areas of the video (such as regions of interest) are preserved in higher quality and less important sections are encoded with reduced detail to optimize storage and bandwidth. The base section, representing the entirety of each video frame, may be encoded as a base layer with lower resolution and frame rate, forming the foundation of the video. Meanwhile, the first separately encoded video segment containing the region of interest may provide a section of the video with a higher resolution and frame rate, forming the focus of the video.

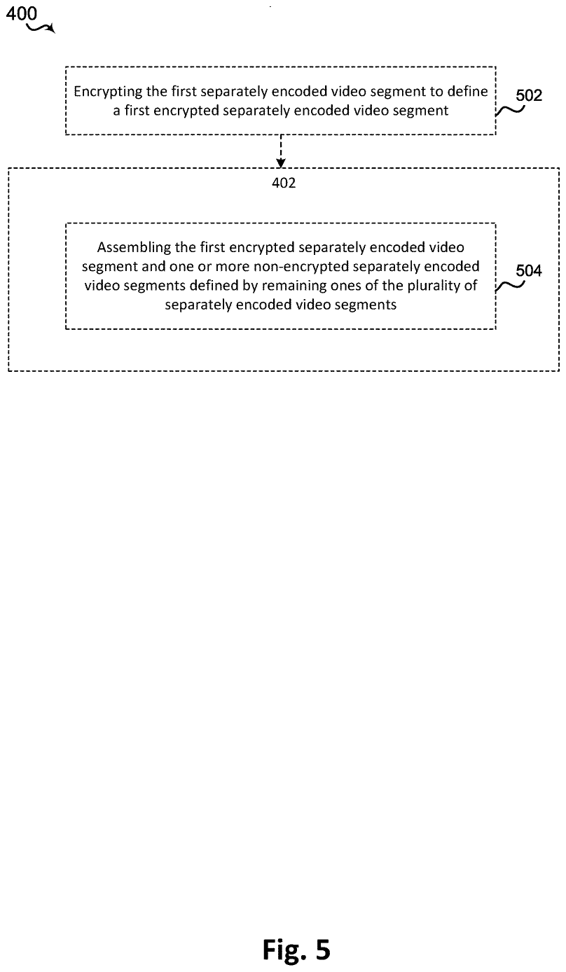

Referring to FIG. 5, in an alternative or additional aspect, at block 502, the method 400 may further include encrypting the first separately encoded video segment to define a first encrypted separately encoded video segment for the region of interest. For example, in an aspect, computer device 101, one or more processors 105, one or more memories 110, video encoding component 115, and/or encrypting component 340 may be configured to or may comprise means for encrypting the first separately encoded video segment to define a first encrypted separately encoded video segment.

For example, the encrypting at block 502 may include applying a cryptographic algorithm to protect content in the first separately encoded video segment while allowing other video segments to remain non-encrypted. In some aspects, the process begins with the first encoded video segment, typically containing sensitive or high-priority content, which is encrypted using any suitable algorithm such as Advanced Encryption Standard (AES) or Rivest-Shamir-Adleman (RSA). The encryption ensures that only authorized users can access or decrypt the protected video segments, enhancing security against unauthorized access or tampering. For example by requiring an authorization identifier that corresponds to a decryption key before an encrypted track layer can be played and by tagging each track's metadata with its encryption status and access permissions to enable selective playback under a DRM workflow. Meanwhile, the remaining video segments, which may contain less sensitive content, remain unencrypted to allow for reduced processing overhead or broader accessibility to anyone regardless of permissions.

In this optional aspect, at block 504, the assembling at block 408 of each of the plurality of separately encoded video segments includes assembling the first encrypted separately encoded video segment and one or more non-encrypted separately encoded video segments defined by remaining ones of the plurality of separately encoded video segments. For example, in an aspect, computer device 101, one or more processors 105, one or more memories 110, video encoding component 115, and/or assembling component 335 may be configured to or may comprise means for assembling the first encrypted separately encoded video segment and one or more non-encrypted separately encoded video segments defined by remaining ones of the plurality of separately encoded video segments.

For example, the assembling at block 504 may include combining the encrypted and non-encrypted video segments into a multi-track video format, maintaining synchronization and compatibility for transmission or storage. The input consists of multiple encoded video segments, where the encrypted segment contains sensitive or high-priority content, while the non-encrypted segments remain accessible for general viewing. Functions and algorithms applied during assembly include multiplexing techniques that synchronize the segments within a container format (e.g., Matroska, MKV) and ensure seamless playback. Additionally, metadata is included to indicate encryption status and access permissions. The output is a structured video file where protected content is secured while non-sensitive data remains openly available. This hybrid encryption approach provides flexibility in data protection, ensuring that critical video data remains secure while allowing efficient streaming or storage of non-sensitive content.

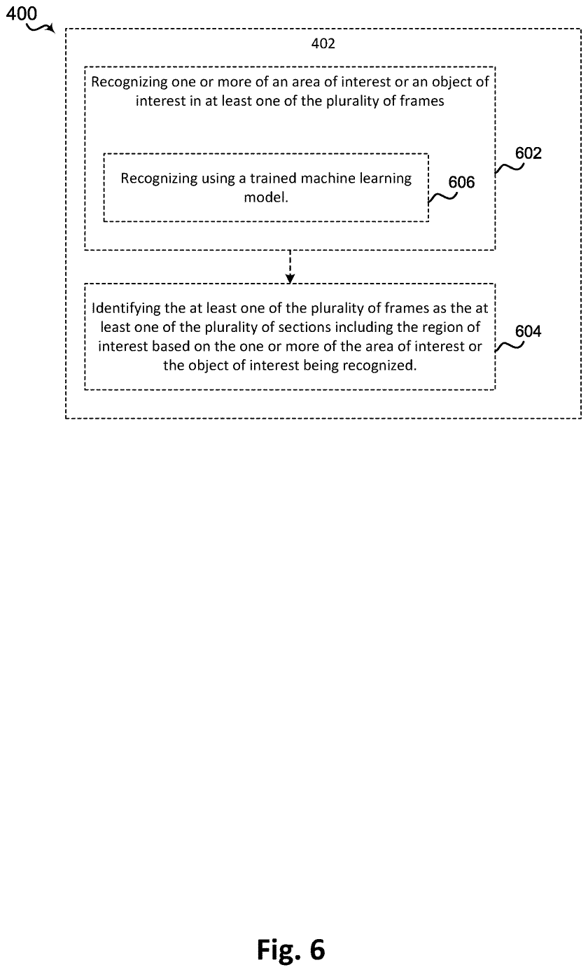

Referring to FIG. 6, in an alternative or additional aspect, at block 602, the identifying at block 402 of the plurality of sections of the plurality of frames of the video further includes recognizing one or more of an area of interest or an object of interest in at least one of the plurality of frames. For example, in an aspect, computer device 101, one or more processors 105, one or more memories 110, video encoding component 115, and/or identifying component 320 may be configured to or may comprise means for recognizing one or more of an area of interest or an object of interest in at least one of the plurality of frames.

In this optional aspect, at block 606, the recognizing at block 602 of the one or more of the area of interest or the object of interest comprises recognizing using a trained ML model.

For example, this may include recognizing an area of interest or an object of interest within at least one frame of the video. The input consists of video frames, which are analyzed using computer vision and machine learning algorithms such as YOLO, Faster R-CNN, or semantic segmentation models to detect specific areas or objects (e.g., an ATM, a person, or a moving vehicle). Feature extraction techniques, including edge detection, optical flow analysis, and saliency mapping, further refine the identification process. The output is a structured dataset marking detected objects or areas.

In this optional aspect, at block 604, the identifying at block 402 of the plurality of sections of the plurality of frames of the video further includes identifying the at least one of the plurality of frames as the at least one of the plurality of sections including the region of interest based on the one or more of the area of interest or the object of interest being recognized. For example, in an aspect, computer device 101, one or more processors 105, one or more memories 110, video encoding component 115, and/or identifying component 320 may be configured to or may comprise means for identifying the at least one of the plurality of frames as the at least one of the plurality of sections including the region of interest based on the one or more of the area of interest or the object of interest being recognized.

For example, the process of identifying at least one frame from a plurality of frames as containing a region of interest is achieved by analyzing one or more factors, such as an area of interest or an object of interest. Input data typically includes sequential frames from a video or image stream, which are processed using computer vision techniques, object detection algorithms (e.g., convolutional neural networks or feature-matching methods), or motion analysis models. These algorithms recognize and track objects or specific regions across frames, enabling the selection of frames that contain relevant content. The output is a refined subset of frames that accurately capture the region of interest, reducing redundant data and optimizing further processing or analysis.

In an alternative or additional aspect, recognizing the one or more of the area of interest or the object of interest comprises recognizing using a trained machine learning model. In this aspect, the trained ML model is trained using a training dataset comprising images of one or more of areas of interest or objects of interest and a label identifying each of the areas of interest or the objects of interest in the images to visually detect and identify as being associated with one or more regions of interest.

In this way, the present disclosure describes enhancing video segmentation by incorporating intelligent recognition techniques. Specifically, the process identifies sections of video frames by recognizing areas of interest or objects within those frames. By analyzing these recognized regions or objects, the system can accurately categorize frames into distinct sections, prioritizing those that include the identified areas or objects of interest. This method improves the precision of video analysis, allowing for more targeted segmentation and better understanding of key content within the video.

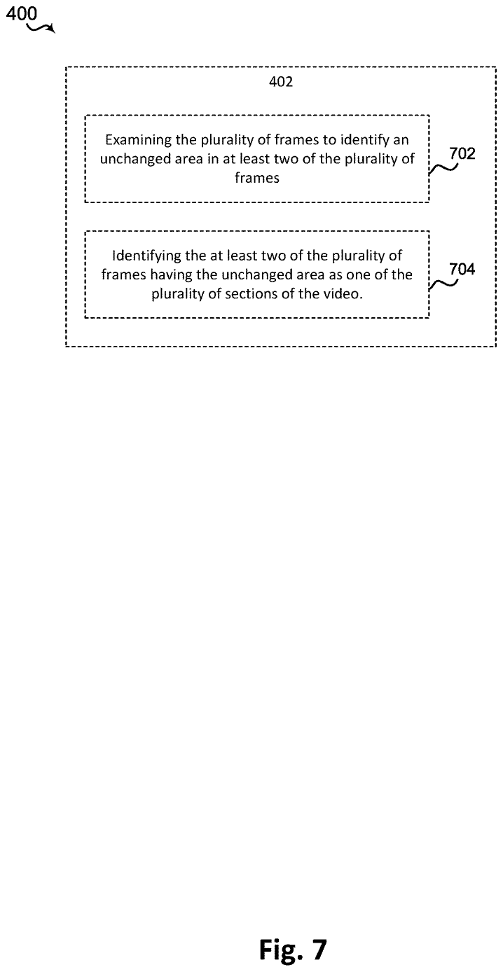

Referring to FIG. 7, in an alternative or additional aspect, at block 702, the identifying at block 402 of the plurality of sections in each of the plurality of frames of the video further includes examining the plurality of frames to identify an unchanged area in at least two of the plurality of frames. For example, in an aspect, computer device 101, one or more processors 105, one or more memories 110, video encoding component 115, and/or identifying component 320 may be configured to or may comprise means for examining the plurality of frames to identify an unchanged area in at least two of the plurality of frames.

For example, identifying an unchanged area in at least two of the plurality of frames at block 704 may involve analyzing pixel values across multiple frames to detect regions (or objects such as an ATM) that remain constant over time. This process may include applying image differencing techniques, such as frame subtraction or background modeling algorithms (e.g., Gaussian Mixture Models or temporal median filtering), to identify static regions where pixel intensity values exhibit minimal variation. Inputs to this process include consecutive video frames, and functions such as thresholding and motion estimation may be applied to differentiate between static and dynamic areas. The output is a mask or set of coordinates representing the unchanged areas, which can be used for optimizing encoding efficiency, reducing computational overhead, or enhancing object detection by filtering out irrelevant background elements.

In this optional aspect, at block 704, the identifying at block 402 of the plurality of sections in each of the plurality of frames of the video further includes identifying the at least two of the plurality of frames having the unchanged area as one of the plurality of sections of the video. For example, in an aspect, computer device 101, one or more processors 105, one or more memories 110, video encoding component 115, and/or identifying component 320 may be configured to or may comprise means for identifying the at least two of the plurality of frames having the unchanged area as one of the plurality of sections of the video.

For example, identifying at least two frames with an unchanged area as one of the sections of the video involves detecting and grouping consecutive frames that contain consistent visual regions. Inputs to this process include multiple frames from the video, which are analyzed using algorithms such as structural similarity (SSIM), histogram comparison, or motion vector analysis to determine regions with little to no change. Functions like frame clustering or temporal segmentation may be applied to classify frames with unchanged areas as a distinct section. The output is a designated segment of the video where the identified unchanged area remains static, which can be leveraged for efficient encoding, scene segmentation, or background stabilization.

The benefit of examining the plurality of frames to identify an unchanged area across at least two frames lies in its ability to efficiently detect stable or repetitive elements within the video. By recognizing areas that remain unchanged across multiple frames, the system can effectively group these frames into a single section, which helps in reducing unnecessary processing. In this way, the present disclosure describes a method to reduce computational complexity in video processing, enable enhanced compression by eliminating redundant data, and improve accuracy in applications such as object tracking and automated editing.

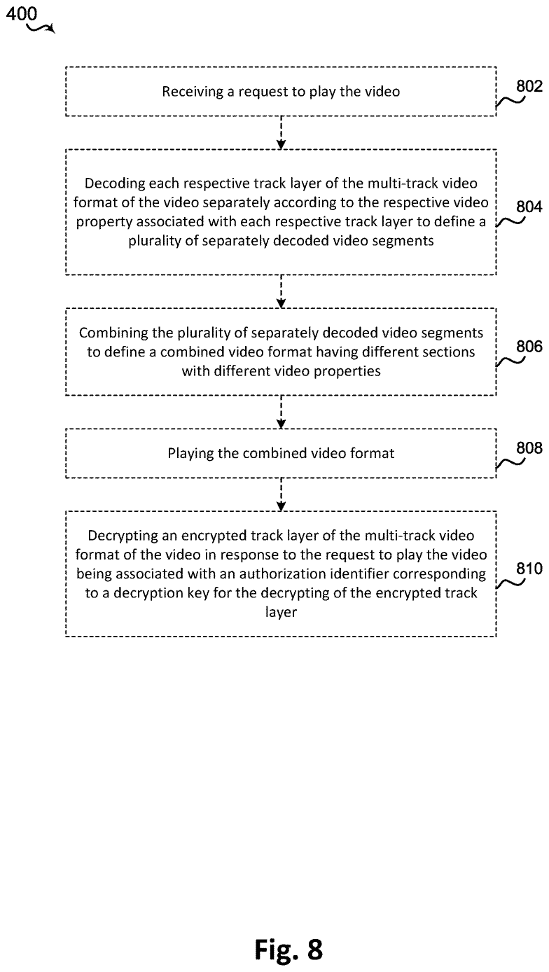

Referring to FIG. 8, in an alternative or additional aspect, at block 802, the method 400 may further include receiving a request to play the video. For example, in an aspect, computer device 101, one or more processors 105, one or more memories 110, video encoding component 115, and/or receiving component 345 may be configured to or may comprise means for receiving a request to play the video via a user interface.

For example, the receiving at block 802 may include receiving a request to play the video involving an input command from a user or system trigger, such as a play button press, an API request, or an automated playback instruction downstream on a device. This request initiates functions within a media player or streaming server, which may include buffer allocation, decoding initialization, and network resource management for efficient content delivery. Algorithms such as adaptive bitrate streaming (ABR) can be applied to dynamically adjust video quality based on network conditions, ensuring smooth playback. The output of this process is the seamless rendering of video frames on a display device, synchronized with audio if applicable.

In this optional aspect, at block 804, the method 400 may further include decoding each respective track layer of the multi-track video format of the video separately according to the respective video property associated with each respective track layer to define a plurality of separately decoded video segments. For example, in an aspect, computer device 101, one or more processors 105, one or more memories 110, video encoding component 115, and/or decoding component 350 may be configured to or may comprise means for decoding each respective track layer of the multi-track video format of the video separately according to the respective video property associated with each respective track layer to define a plurality of separately decoded video segments.

For example, the decoding at block 804 may include processing multiple layers of video data independently based on their designated characteristics, such as resolution, frame rate, or bitrate. Inputs include encoded video streams with distinct track layers, each containing variations of the content optimized for different playback conditions. Decoding functions may utilize codecs like H.264, H.265, or AV1, applying algorithms such as motion compensation, entropy decoding, and inverse transform operations to reconstruct the video data. The output is a set of separately decoded video segments, which can be dynamically combined or selected based on playback requirements.

In this optional aspect, at block 806, the method 400 may further include combining the plurality of separately decoded video segments to define a combined video format having different sections with different video properties. For example, in an aspect, computer device 101, one or more processors 105, one or more memories 110, video encoding component 115, and/or combining component 355 may be configured to or may comprise means for combining the plurality of separately decoded video segments to define a combined video format having different sections with different video properties.

For example, the combining at block 806 may include merging independently processed video layers into a unified output while preserving their respective properties, such as resolution, frame rate, or encoding settings. Inputs include separately decoded video segments that may differ in visual quality, compression efficiency, or content variations. Functions such as frame composition, temporal synchronization, and adaptive rendering algorithms are applied to seamlessly integrate these segments while ensuring smooth transitions between different sections. The output is a cohesive video file in a multi-track video format where different sections retain their unique video properties, enabling efficient playback across diverse devices and network conditions.

In this optional aspect, at block 808, the method 400 may further include playing the combined video format. For example, in an aspect, computer device 101, one or more processors 105, one or more memories 110, video encoding component 115, and/or playing component 360 may be configured to or may comprise means for playing the combined video format.

For example, the playing at block 808 may include rendering the unified video stream while maintaining the different sections with their respective video properties. Inputs include the merged video file or stream, which may contain segments with varying resolutions, frame rates, or encoding parameters. Functions such as media decoding, frame buffering, and adaptive playback control ensure smooth rendering and synchronization of the video and audio tracks. Algorithms like dynamic bitrate switching and display optimization may be applied to enhance playback performance based on device capabilities and network conditions. The output is a seamless viewing experience where different sections of the video are presented without interruption. The advantages of this approach include improved playback adaptability, optimized resource utilization, enhanced visual quality across different content sections, and a more efficient user experience across various devices and network environments.

In this optional aspect, at block 810, the method 400 may further include decrypting an encrypted track layer of the multi-track video format of the video in response to the request to play the video being associated with an authorization identifier corresponding to a decryption key for the decrypting of the encrypted track layer. For example, in an aspect, computer device 101, one or more processors 105, one or more memories 110, video encoding component 115, and/or decrypting component 365 may be configured to or may comprise means for decrypting an encrypted track layer of the multi-track video format of the video in response to the request to play the video being associated with an authorization identifier corresponding to a decryption key for the decrypting of the encrypted track layer.

For example, the decrypting at block 810 may include verifying the provided authorization identifier and using the corresponding decryption key to unlock protected video content. Inputs include the encrypted track layer, an authorization request, and a decryption key, which may be retrieved from a digital rights management (DRM) system such as Widevine, FairPlay, or PlayReady. Functions such as key exchange, cryptographic decryption (e.g., AES decryption), and authentication verification are applied to securely restore the original video data while preventing unauthorized access. The output is a decrypted video stream that can be processed for playback. The advantages of this approach include enhanced content security, controlled access to premium or restricted media, protection against piracy, and the ability to deliver secure video streaming while maintaining a seamless user experience.

The benefits of this approach include enhanced flexibility and optimization in video playback. By decoding each track layer separately based on its respective video property, the system can handle diverse video formats, such as those with varying resolutions, frame rates, or bitrates, in a more efficient and tailored manner. This enables a higher level of control over how each segment is processed, allowing for customized playback experiences. Once the video segments are decoded and combined into a unified format, the video can be played seamlessly, ensuring smooth performance while preserving the distinct properties of each section. This method also facilitates more efficient storage and streaming, as it allows for the selective handling of different video components based on their specific properties.

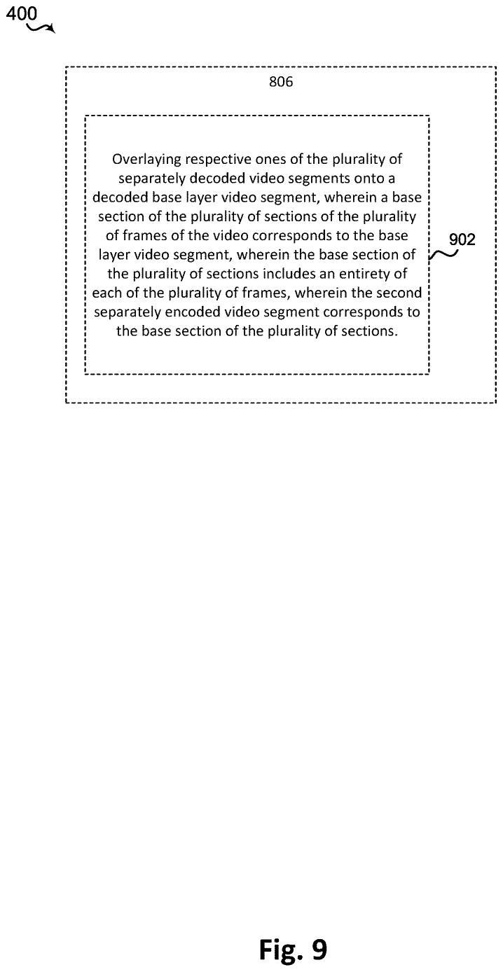

Referring to FIG. 9, in an alternative or additional aspect, at block 902, the combining at block 806 of the plurality of separately decoded video segments to define the combined video format further includes overlaying respective ones of the plurality of separately decoded video segments onto a decoded base layer video segment, wherein a base section of the plurality of sections of the plurality of frames of the video corresponds to the base layer video segment, wherein the base section of the plurality of sections includes an entirety of each of the plurality of frames, wherein the second separately encoded video segment corresponds to the base section of the plurality of sections.

For example, overlaying separately decoded video segments onto a decoded base layer video segment involves compositing multiple video layers while ensuring synchronization and alignment with the base section, which spans the entire frame. Inputs include the decoded base layer video and additional video segments, such as overlays, enhancements, or supplementary visual elements. Functions like alpha blending, spatial alignment, and pixel composition are applied to seamlessly integrate the overlaying segments while preserving visual fidelity. Algorithms such as motion estimation and region-based rendering ensure that the overlays maintain proper positioning and quality. The output is a fully composited video where the base layer remains intact, and additional segments enhance or modify specific areas. The advantages of this approach include efficient multi-layer rendering, support for dynamic content augmentation, improved video customization, and optimized encoding.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of video encoding, comprising:
identifying a plurality of sections of a plurality of frames of a video, wherein at least one of the plurality of sections is identified as including a region of interest;
partitioning each of the plurality of sections of the plurality of frames into a plurality of separate video segments;
encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest; and
assembling each of the plurality of separately encoded video segments as a respective track layer in a multi-track video format of the video for transmission or storage.

2. The method of claim 1, wherein the respective video property comprises at least one of a codec, a resolution, a framerate, a bit rate, a color depth, or an encoding profile.

3. The method of claim 1, wherein the first video property comprises at least one of a first resolution or a first framerate and the second video property comprises at least one of a second resolution or a second framerate, wherein the first resolution is greater than the second resolution, and wherein the first framerate is greater than the second framerate.

4. The method of claim 3, wherein a base section of the plurality of sections of the plurality of frames of the video corresponds to a base layer of the video that includes an entirety of each of the plurality of frames, wherein the second separately encoded video segment corresponds to the base section of the plurality of sections.

5. The method of claim 1, further comprising:
encrypting the first separately encoded video segment to define a first encrypted separately encoded video segment,
wherein the assembling of each of the plurality of separately encoded video segments includes assembling the first encrypted separately encoded video segment and one or more non-encrypted separately encoded video segments defined by remaining ones of the plurality of separately encoded video segments.

6. The method of claim 1, wherein identifying the plurality of sections of the plurality of frames of the video further comprises:
recognizing one or more of an area of interest or an object of interest in at least one of the plurality of frames; and
identifying the at least one of the plurality of frames as the at least one of the plurality of sections including the region of interest based on the one or more of the area of interest or the object of interest being recognized.

7. The method of claim 6, wherein recognizing the one or more of the area of interest or the object of interest comprises recognizing using a trained machine learning model.

8. The method of claim 7, wherein the trained machine learning model is trained using a training dataset comprising images of one or more of areas of interest or objects of interest and a label identifying each of the areas of interest or the objects of interest in the images to visually detect and identify as being associated with one or more regions of interest.

9. The method of claim 1, wherein identifying the plurality of sections in each of the plurality of frames of the video further comprises:
examining the plurality of frames to identify an unchanged area in at least two of the plurality of frames; and
identifying the at least two of the plurality of frames having the unchanged area as one of the plurality of sections of the video.

10. The method of claim 1, further comprising:
receiving a request to play the video;
decoding each respective track layer of the multi-track video format of the video separately according to the respective video property associated with each respective track layer to define a plurality of separately decoded video segments;
combining the plurality of separately decoded video segments to define a combined video format having different sections with different video properties; and
playing the combined video format.

11. The method of claim 10, further comprising:
decrypting an encrypted track layer of the multi-track video format of the video in response to the request to play the video being associated with an authorization identifier corresponding to a decryption key for the decrypting of the encrypted track layer.

12. The method of claim 10, wherein combining the plurality of separately decoded video segments to define the combined video format further comprises:
overlaying respective ones of the plurality of separately decoded video segments onto a decoded base layer video segment, wherein a base section of the plurality of sections of the plurality of frames of the video corresponds to the base layer video segment, wherein the base section of the plurality of sections includes an entirety of each of the plurality of frames, wherein the second separately encoded video segment corresponds to the base section of the plurality of sections.

13. An apparatus for video encoding, comprising:
one or more memories; and
one or more processors coupled with one or more memories and configured, individually or in combination, to:
identify a plurality of sections of a plurality of frames of a video, wherein at least one of the plurality of sections is identified as including a region of interest;
partition each of the plurality of sections of the plurality of frames into a plurality of separate video segments;
encode each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest; and
assemble each of the plurality of separately encoded video segments as a respective track layer in a multi-track video format of the video for transmission or storage.

14. The apparatus of claim 13, wherein the respective video property comprises at least one of a codec, a resolution, a framerate, a bit rate, a color depth, or an encoding profile.

15. The apparatus of claim 13, wherein the first video property comprises at least one of a first resolution or a first framerate and the second video property comprises at least one of a second resolution or a second framerate, wherein the first resolution is greater than the second resolution, and wherein the first framerate is greater than the second framerate.

16. The apparatus of claim 15, wherein a base section of the plurality of sections of the plurality of frames of the video corresponds to a base layer of the video that includes an entirety of each of the plurality of frames, wherein the second separately encoded video segment corresponds to the base section of the plurality of sections.

17. The apparatus of claim 13, wherein the one or more processors are further configured to:
encrypt the first separately encoded video segment to define a first encrypted separately encoded video segment, and
wherein to assemble each of the plurality of separately encoded video segments the one or more processors are further configured to assemble the first encrypted separately encoded video segment and one or more non-encrypted separately encoded video segments defined by remaining ones of the plurality of separately encoded video segments.

18. The apparatus of claim 13, wherein to identify the plurality of sections of the plurality of frames of the video the one or more processors are further configured to:
recognize one or more of an area of interest or an object of interest in at least one of the plurality of frames; and
identify the at least one of the plurality of frames as the at least one of the plurality of sections including the region of interest based on the one or more of the area of interest or the object of interest being recognized.

19. The apparatus of claim 18, wherein to recognize the one or more of the area of interest or the object of interest the one or more processors are further configured to recognize using a trained machine learning model.

20. A non-transitory computer readable medium storing thereon computer executable instructions for video encoding, including instructions for performing:
identifying a plurality of sections of a plurality of frames of a video, wherein at least one of the plurality of sections is identified as including a region of interest;
partitioning each of the plurality of sections of the plurality of frames into a plurality of separate video segments;
encoding each of the plurality of separate video segments separately with a respective video property to define a plurality of separately encoded video segments, wherein the plurality of separately encoded video segments includes at least a first separately encoded video segment that is encoded with a first video property and a second separately encoded video segment that is encoded with a second video property that is different from the first video property, wherein the first separately encoded video segment includes the at least one of the plurality of sections including the region of interest; and
assembling each of the plurality of separately encoded video segments as a respective track layer in a multi-track video format of the video for transmission or storage.
